(19) United States
(12) Patent Application Publication
(10) Pub. No.: US 2009/0208803 A1
(43) Pub. Date: Aug. 20, 2009

(54) FLOW FIELD FOR FUEL CELL AND FUEL CELL STACK

(76) Inventor: Simon Farrington, Vancouver (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 12/033,778

(22) Filed: Feb. 19, 2008

(51) Int. Cl. H01M 8/04; H01M 8/10; H01M 8/00

(52) U.S. Cl. 429/30; 429/34; 29/623.1

(57) ABSTRACT

A flow field design for fuel cell is disclosed which optimizes water management for local operating conditions where the depth profile of the flow field varies from the reactant inlet to the reactant outlet and also varies across the flow field.

### BACKGROUND

1. Field

This disclosure relates generally to fuel cells and, more specifically, to a fuel cell flow field plate and flow field design, which optimizes for local operating conditions.

2. Description of the Related Art

Fuel cells convert fuel and oxidant to electricity and reaction product. Solid polymer fuel cells typically employ a membrane electrode assembly (MEA) consisting of a proton exchange membrane (PEM) disposed between two porous, electrically conductive gas diffusion layers (GDLs). Catalytic material is disposed at the interface between the PEM and the GDL forming two electrodes, namely an anode and cathode. At the anode, fuel, typically in the form of hydrogen gas, reacts at the electrocatalyst in the presence of the PEM to form hydrogen ions and electrons. At the cathode, oxidant reacts in the presence of the PEM at the electrocatalyst to form anions. The PEM isolates the fuel stream from the oxidant stream and facilitates the migration of the hydrogen ions from the anode to the cathode where they react with anions formed at the cathode. The electrons pass through an external circuit, creating a flow of electricity. The net reaction product is water. The anode and cathode reactions in hydrogen gas fuel cells are shown in the following equations:

H₂→2H⁺+2e⁻ (1)

½O₂+2H⁺2e⁻→H₂O (2)

The MEA is typically further interposed between flow field plates which act as current collectors, provide support to the MEA, and provide access of the reactants, fuel and oxidant, to the anode and cathode, respectively. The flow field plates also provide for the removal of product water formed during operation of the cell. Flow field plates often comprise channels for these purposes.

The local operating conditions in an operating fuel cell vary across the active area of each electrode. As a first example, as the oxidant is consumed and water is produced, the oxidant partial pressure decreases. This results in a greater current density in a region near the reactant inlet and a corresponding increase in temperature, which may decrease the local relative humidity. Similarly, the flow field and GDL may have too much product water, which can result in localized flooding, uneven performance and increased mass transport losses. As a second example, the difference in temperature between a core of the fuel cell stack and the external ambient temperature may create a temperature gradient across the flow field such that the local temperature towards an outside of the fuel cell may be lower than the local temperature towards an inside of the fuel cell. This difference in local temperature may affect the position along the flow field channel where water condenses or aggregates.

Local operating conditions and local water content may also vary depending on flow sharing, reactant relative humidity, and reactant stoichiometry as disclosed in Stumper, J. in Integrated Flow Visualization and Current Mapping of a PEM Fuel Cell, Abstract 611, 210th ECS Meeting, Cancun Mexico, October 2006.

Flow field plates and fuel cells in the art however, do not sufficiently address all of these local operating conditions. Therefore, there remains a need for improved fuel cells, particularly with regard to flow field design that optimizes for the effect of local operating conditions within an operating fuel cell. The present disclosure fulfills this need and provides further related advantages.

### BRIEF SUMMARY

One embodiment may be summarized as a flow field plate including: a first surface comprising a plurality of first channels; wherein a first subset of the plurality of first channels has a first depth profile; wherein a second subset of the plurality of first channels has a second depth profile; and wherein the second depth profile differs from the first depth profile.

One embodiment may be summarized as a fuel cell stack including a plurality of fuel cells coupled in series, at least one of the plurality of fuel cells comprising a pair of flow field plates, a pair of fluid distribution layers interposed between the flow field plates; an proton exchange membrane interposed between the fluid distribution layers; and an electrocatalyst interposed between each of the fluid distribution layers and proton exchange membrane wherein at least one of the flow field plates comprises: a first surface comprising a plurality of first channels; wherein a first subset of the plurality of first channels has a first depth profile; wherein a second subset of the plurality of first channels has a second depth profile; and wherein the second depth profile differs from the first depth profile.

One embodiment may be summarized as a flow field plate including: a first surface comprising a plurality of first channels; a second surface comprising a plurality of second channels; wherein the width of the at least a portion of the plurality of first and second channels is substantially constant; wherein an inner subset of the plurality of first channels has a first depth profile; wherein an outer subset of the plurality of first channels has a second depth profile; wherein second depth profile varies from deep to shallow from an inlet to an outlet; wherein the second depth profile is different from the first depth profile; and wherein the sum of the depth of the first and second channels is constant along the length of the channels.

A method for making a flow field plate including disposing on a first surface, a plurality of first channels; wherein a first subset of the plurality of first channels has a first depth profile; wherein a second subset of the plurality of first channels has a second depth profile; and wherein the second depth profile differs from the first depth profile.

The first depth profile may vary from deep to shallow from a first inlet to a first outlet. The first depth profile may change in a linear fashion, in a ramp-wise fashion or in a non-linear fashion.

The width of the plurality of first channels may be substantially constant.

The flow field plate may further include a second surface including a plurality of second channels wherein the sum of the depth of the first and second channels is substantially constant along the length of the channels.

The flow field plate may be a metal or may be comprised of carbon.

These and other aspects of this disclosure will be evident upon review of the attached figures and following detailed description.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is an exploded sectional view of a conventional fuel cell.

FIG. 2A is a plan view of a flow field plate according to one illustrated embodiment.

FIG. 2B is a plan view of water content in a flow field in a conventional design.

FIG. 3A is a cross sectional view of a portion of a flow field plate taken along section line A-A of FIG. 2A according to one illustrated embodiment.

FIG. 3B is a cross sectional view of a portion of a flow field plate taken along section line B-B of FIG. 2A according to one illustrated embodiment.

FIG. 4A is a cross sectional view of a portion of a flow field plate taken along section line A-A of FIG. 2A according to another embodiment.

FIG. 4B is a cross sectional view of a portion of a flow field plate taken along section line B-B of FIG. 2A according to another illustrated embodiment.

FIG. 5A is a cross sectional view of a portion of a flow field plate taken along section line A-A of FIG. 2A according to yet another illustrated embodiment.

FIG. 5B is a cross sectional view of a portion of a flow field plate take along section line B-B of FIG. 2A according to yet another illustrated embodiment.

FIG. 6 is a cross sectional view of a portion of a flow field plate taken along section line A-A of FIG. 2A according to another illustrated embodiment.

FIG. 7A is a cross sectional view of a flow field plate taken along section lines I−1 and II-II of FIG. 2A according to one illustrated embodiment.

FIG. 7B is a cross sectional view of a flow field plate take along section lines I-I and II-II of FIG. 2A according to one illustrated embodiment.

### DETAILED DESCRIPTION

The headings and Abstract of the Disclosure provided herein are for convenience only and do not interpret the scope or meaning of the embodiments.

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with fuel cells, fuel cell stacks, MEAs and/or PEMs have not been shown or described in detail to avoid unnecessarily obscuring descriptions of the embodiments.

Unless the context requires otherwise, throughout the specification and claims which follow, the word “comprise” and variations thereof, such as “comprises” and “comprising” are to be construed in an open, inclusive sense, that is as “including but not limited to”.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

As used herein, the terms ‘deep’ and ‘shallow’ are relative terms and do not refer to any particular value or scale.

A flow field plate's water clearing ability is determined in part by a volume flow rate of gas in the flow field. Two water clearing thresholds can be defined. The first threshold, the velocity threshold, is the minimum flow velocity required to overcome the anchor force of water droplets in a flow field, either within a flow field channel or emerging from the GDL, into the flow field. By this mechanism, the gas flow imparts a drag force on the droplet which, if above the velocity threshold, strips the droplet from the surface of the GDL or flow field channel and entrains the droplet into the gas flow. In this case, the greater velocity of the flow, the greater velocity stripping force. The second threshold, the piston force threshold, is the threshold required to act on water that fills the cross section of a flow field channel. In this case, the piston force is determined by the pressure difference acting on the blockage, which is affected by flow velocity of the constituent reactant. More piston force results in greater water clearing ability.

Greater flow velocity however, requires greater parasitic load from balance of plant components in the fuel cell system such as compressors or blowers and increases the effective resistance to flow in the flow field. As such, flow velocity should only be employed as a water removal tool where required, for example, where the local operating conditions results in a greater amount of liquid water. To have low parasitic load, low flow resistance and high water clearing ability, fuel cell systems in the art often switch from a first mode of supplying enough reactant flow to sustain the reaction rate to a second mode to provide a higher flow inlet pressure and velocity to increase the water clearing ability.

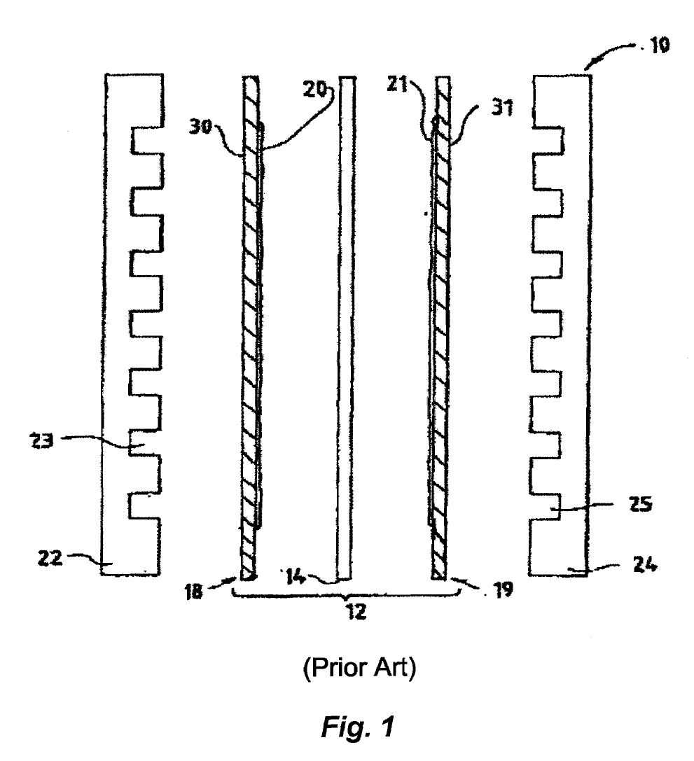

FIG. 1 illustrates a conventional fuel cell 10 where the flow field channels are of substantially constant dimensions from the inlet to the outlet. Fuel cell 10 includes MEA 12 interposed between anode flow field plate 22 and cathode flow field plate 24. MEA 12 consists of PEM 14 interposed between two electrodes, namely, anode 18 and cathode 19. In conventional fuel cells, anode 18 and cathode 19 comprise a fluid distribution layer of porous electrically conductive sheet material 30 and 31, respectively. Sheet material 30, 31 is typically composed of materials such as, for example, carbon fiber paper, woven or non-woven carbon fabric, or metal mesh or gauze. Each fluid distribution layer has a thin layer of electrocatalyst 20 and 21, such as platinum black or a carbon-supported platinum catalyst, disposed on one of the major surfaces at the interface with membrane 14 to render each electrode electrochemically active. MEA 12 is interposed between anode flow field plate 22 and cathode flow field plate 24. Anode flow field plate 22 has at least one fuel passage 23 formed in its surface facing anode fluid distribution layer 30. Cathode flow field plate 24 has at least one oxidant flow passage 25 formed in its surface facing cathode fluid distribution layer 31. When assembled against the cooperating surfaces of fluid distribution layers 30 and 31, passages 23 and 25 form reactant flow passages for the fuel and oxidant, respectively. In fuel cell 10 reactant flow passages are formed by the cooperative interaction of the flow field plates and the fluid distribution layers.

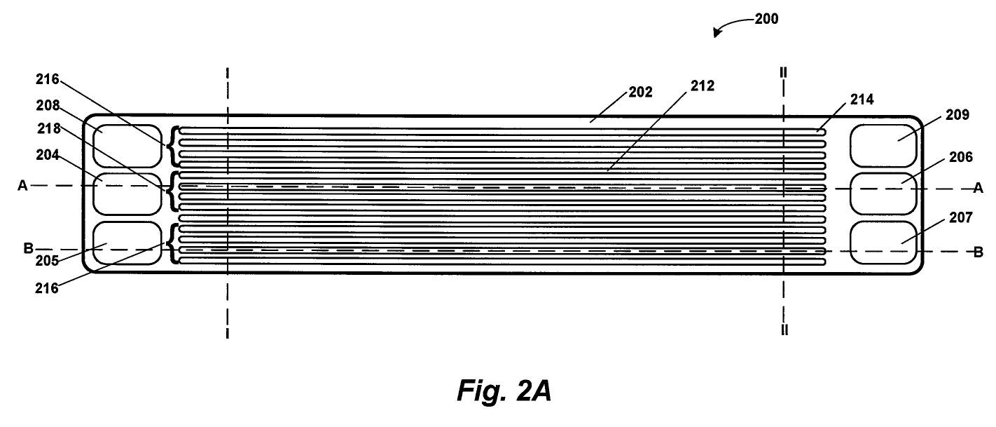

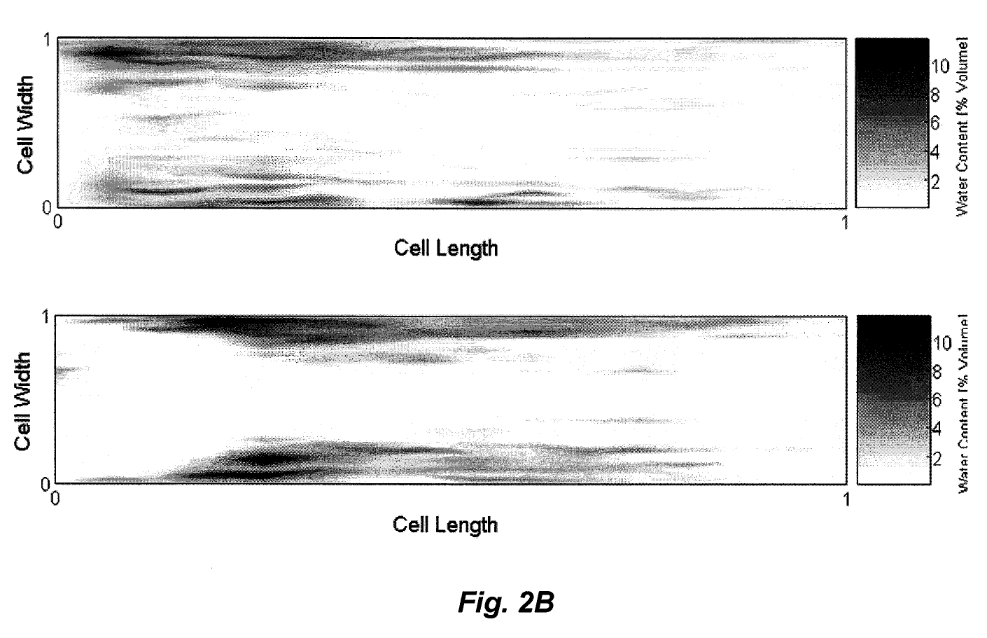

FIG. 2A illustrates flow field plate 200 according to one embodiment. Flow field plate 200 has a major surface 202, an opposing second major surface (not shown), an oxidant inlet 204, an oxidant outlet 206, a fuel inlet 205, a fuel outlet 207, a coolant inlet 208 and a coolant outlet 209. Major surface 202 has a flow field 212 which is fluidly coupled to the oxidant inlet 204 and outlet 206 for directing an oxidant stream across the flow field 212. In FIG. 2A, flow field 212 is comprised of a plurality of channels 214 where some channels are located towards the side of the flow field (e.g., channels 216) and where some channels are more centrally located (e.g., channels 218).

The opposing major surface (not shown), similarly, has an opposing flow field (not shown) which is fluidly coupled to the fuel inlet 205 and outlet 207 for directing a fuel stream, for example in the form of hydrogen or methanol, across the second flow field 203. Opposing flow field may similarly be comprised of a plurality of channels 215 (not shown in FIG. 2A).

The plurality of channels 214 each have an associated depth profile. As will be seen below, the depth profiles of channels 214 may vary from the oxidant inlet 204 to the outlet 206 (fore-aft) and may also vary across major surface 202 (side-side) to address local operating conditions. As an example, ambient external temperature may create local operating conditions within the flow field such that channels 216 may have a lower operating temperature as compared to channels 218. Local operating conditions have been observed in Stumper, J. in Integrated Flow Visualization and Current Mapping of a PEM Fuel Cell, Abstract 611, 210th ECS Meeting, Cancun Mexico, October 2006. FIG. 2B shows maps of measured water content (% volume) for a conventional PEM fuel cell flow field as a function of position at operating temperatures of 55 Celsius and 70 Celsius respectfully, as from the above-referenced disclosure by Stumper, J. The upper portion of FIG. 2B shows measured water content in the cathode at 55 degrees Celsius where darker portions show greater water content, generally located towards the inlet and outer portions of the flow field. The lower portion of FIG. 2B shows measured water content in the cathode at 55 degrees Celsius where darker portions show greater water content, generally located towards the inlet and outer portions of the flow field. As observed, during operation of the fuel cell stack, more water may condense and collect in outer channels as compared inner channels. Other parameters such as reactant relative humidity and stoichiometry also create local operating conditions.

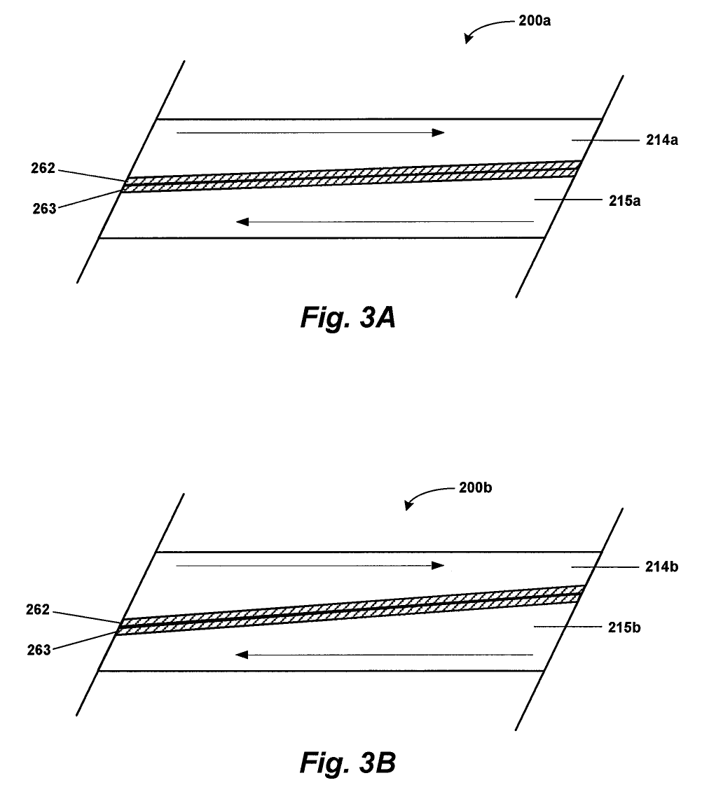

FIG. 3A is a cross sectional view of a portion of flow field plate 200a taken along line A-A of FIG. 2A, according to one illustrated embodiment showing the depth of channel 214a decreasing in a linear fashion from the oxidant inlet 204 (not shown in FIG. 3A) to the oxidant outlet 206 (not shown in FIG. 3A). As a result, the velocity of the reactant flow within channel 214a will increase as it travels from the oxidant inlet 204 to outlet 206. This reduction in the channel depth allows a reduction in the minimum flow rate required (as measured at the oxidant inlet) to remove liquid water from the flow field. In addition, by varying the channel depth but leaving the channel width (and channel landing) constant, reactant flow resistance, mass transport losses, ohmic losses and MEA contact areas are conserved. Constant channel and landing width also reduces manufacturing complexity. (Note: FIG. 3A also shows subplates 262,263 which are described in greater detail below).

FIG. 3B is a cross sectional view of a portion of flow field plate 200b taken along line B-B of FIG. 2A showing the depth profile of channel 214b decreasing in a linear fashion where the slope of the depth profile gradient is greater than that depicted in FIG. 3A. By having a greater slope, channel 214b will have a more pronounced associated increase in flow rate than that in channel 214a, depicted in FIG. 3A, optimizing for local operating conditions at the side of the flow field plate.

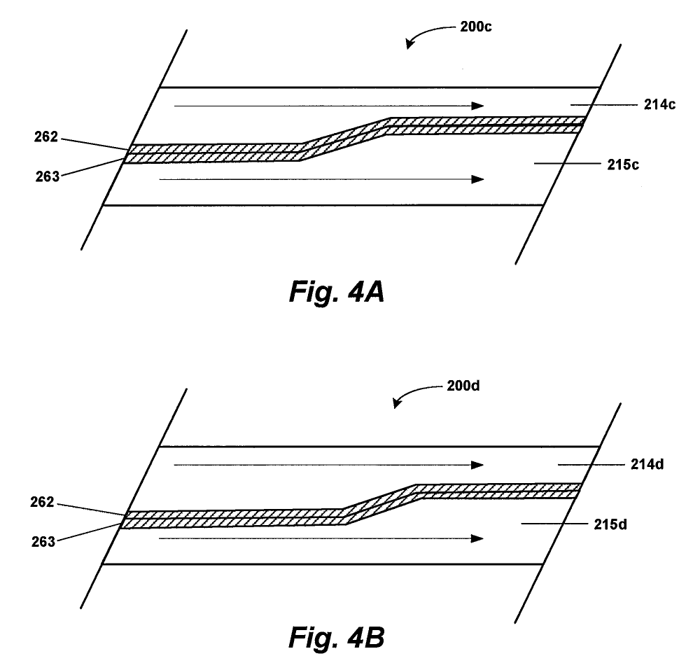

The depth profile of channels 214 need not vary from the oxidant inlet 204 to outlet 206 in a linear fashion. For example, FIG. 4A is a cross sectional view of a portion of flow field plate 200c along taken line A-A of FIG. 2A, according to another embodiment showing the depth profile of channel 214a decreasing in a ramp-wise fashion approximately ½ of the way along the length of the channel (as shown). Also for example, FIG. 4B, is a cross sectional view of a portion of flow field plate 200d taken along line B-B of FIG. 2A, showing the depth profile of channel 214d decreasing in a ramp-wise fashion approximately ⅔ of the way along the length of the channel (as shown), thus being more tuned to local operating conditions, for example according to the flow sharing along channels 218.

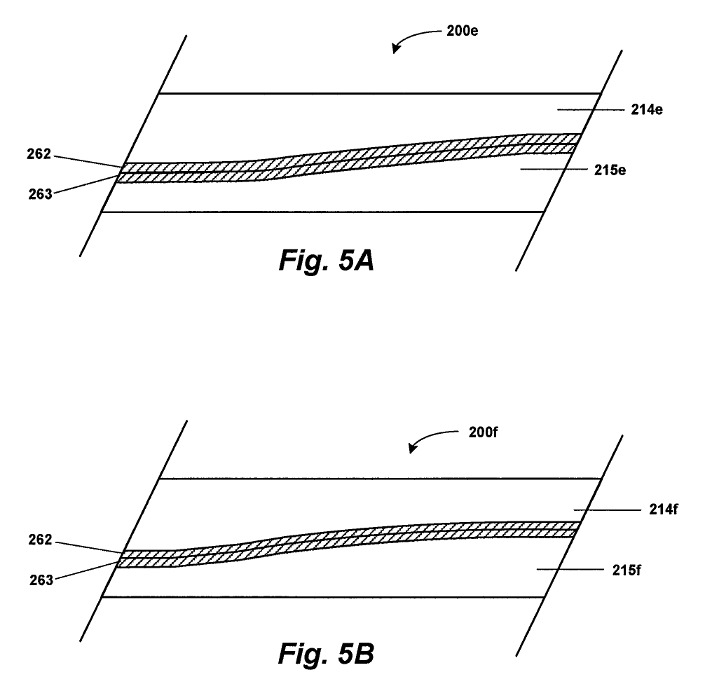

FIG. 5A is a cross sectional view of a portion of flow field plate 200e taken along line A-A of FIG. 2A according to yet another illustrated embodiment where the depth profile of channel 214e decreases in a non-linear fashion which follows, for example, a characteristic hydration profile associate with the channel 214e. That is, a depth of the channel varies as a function of a predicted change in relative humidity along the length of the channel. FIG. 5B is a cross sectional view of a portion of flow field plate 200f taken along line B-B of FIG. 2A where the depth profile of channel 214f decreases similarly, in a non-linear fashion as a function of a predicted change in a hydration profile of channel 214f.

Not all channels 214 must vary in depth. Some channels may have a constant depth profile, if desired. For example, channels 218 in FIG. 2A may have a substantially constant depth profile whereas channels 216 may have a depth profile that varies in a manner as described above or to otherwise optimize for other local operating/operational conditions. Alternatively, channels 216 in FIG. 2A may have a substantially constant depth profile along at least a portion of its length whereas channels 218 may have a depth profile that varies along at least a portion of its length.

The opposing major surface 203, flow field 213 and the associated plurality of channels 215 are not depicted in FIG. 2A. However, FIGS. 3A-5B depict a portion of a corresponding channel 215a-215f in cross section. In each of FIGS. 3A-5B, the web thickness of subplates 262, 263 remains substantially constant and hence the depth profile of the depicted channel 215a-215f varies in accordance with the depth profile of the associated channel 214a-214f. This may occur where a flow field plate (or any constituent subplate) is pressed or stamped out of a metallic sheet, for example. In such embodiments, the sum of depth of a first channel and an associated second channel will be substantially constant along the length of the channel.

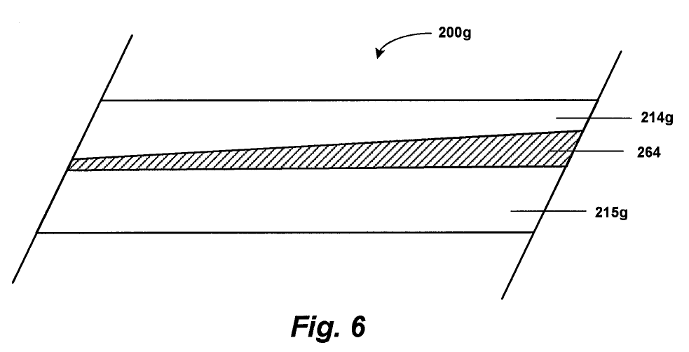

However, when flow field plate 200 is manufactured out of a material where the web thickness need not be substantially constant, the corresponding channels 215 need not vary in accordance with the depth profile of associated channels 214, and variation in the thickness of material of flow field plate 200 may make up the difference in depths of channels 214 and 215. Examples include where flow field plate (or any constituent subplate) is milled, or cast out of metal or such as where the plate is milled, pressed or cast out of a carbonaceous material such as graphite, suitable graphite materials include expanded graphite sheets, such as are available from Advanced Energy Technology, Inc. (Lakewood, Ohio, USA) under the tradename GRAFOIL. FIG. 6 is a cross sectional view of a portion of flow field plate 200g taken along line A-A of FIG. 2A according to yet another illustrated embodiment where the web thickness 264 is not substantially constant and shows that the depth profile of channel 215g does not vary in accordance with the depth profile of associated channel 214g. While the depth profile of channel 215g is shown in FIG. 6 to be substantially constant, it may vary along its length, if desired.

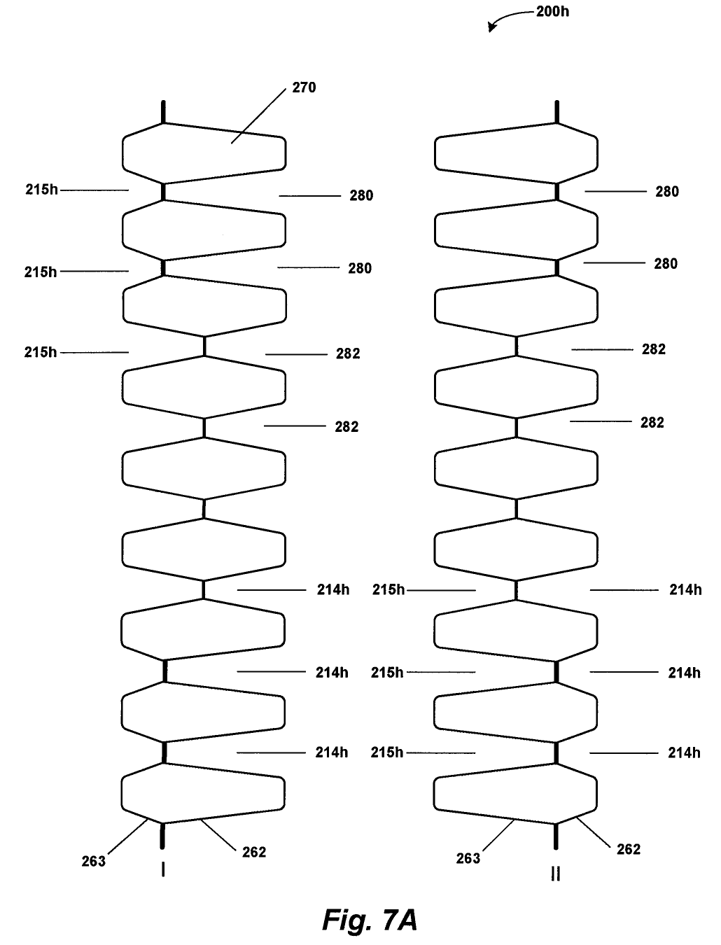

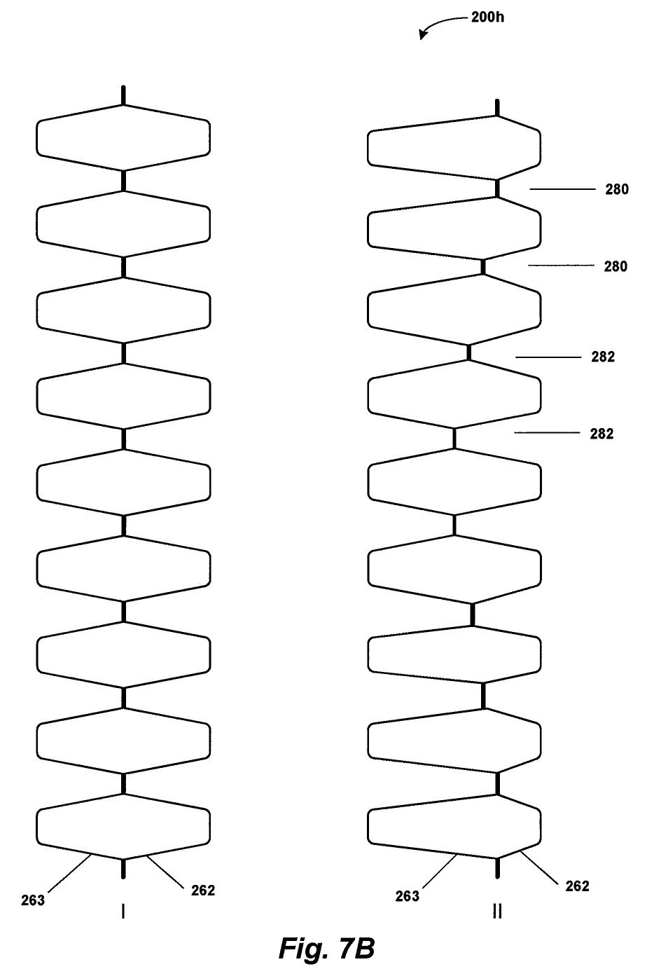

FIG. 7A is a cross sectional view of a flow field plate 200h taken along lines I-I and II-II of FIG. 2A according to one illustrated embodiment showing how channels 214 vary in depth profile across the flow field 212h to optimize for local operating conditions (in addition to varying along flow field 212a-212g from inlet to outlet as shown in FIGS. 3A-6). FIG. 7A shows a plurality of channels 214h and a plurality of associated channels 215h. Channels 280 have one depth profile which varies in depth becoming shallower from the inlet to the outlet whereas channels 282 have another depth profile, which in this example, does not vary in depth from the inlet to the outlet. Such an arrangement of depth profiles addresses or accommodates local operating conditions across the flow field plate 200h such as those shown in FIG. 2B.

FIG. 7B is a cross sectional view of a flow field plate 200i taken along lines I-I and II-II of FIG. 2A according to one illustrated embodiment where channels, 284, 286, 288, 290 each have an associated depth profile which differs from another. In this example, the channels 214 positioned towards the outside of the flow field plate have depth profile which has a greater transition from deep to shallow so as to better optimize or accommodate for local operating conditions towards the outside of the flow field plate 200i. Other depth profiles across the flow field plate may be employed by a person of ordinary skill in the art to optimize or accommodate for other local operating conditions, as desired. For example, it may be desired to have inside channels vary in depth to one degree where outer channels remain substantially constant or vary in depth to a lesser degree. The cross-over from inside channels to outside channels across the flow field may be chosen by a person of ordinary skill in the art to optimize for other local operating conditions, as desired.

Channels 214 may have multiple transitions. As an example, channel 214 may transition from deep to shallow in a ramp-wise fashion at one position and may then transition again in a second ramp-wise fashion to a more shallow depth at a second position (e.g., successive linear ramps with transitions in between). Channels 214 may also have multiple, differing types of transitions. As an example, channel 214 may transition from deep to shallow in a ramp-wise fashion at one position along the channel and may then continue to transition to a more shallow depth in a linear fashion along the remaining length of the channel. Such disclosed embodiments may be useful to optimize flow field water management.

Initial and final depths, the type of transition (linear, ramp or non-linear, as examples), the number of transitions, the degree of transition and the position of a transition may be chosen for each channel to optimize for local operating conditions. The depth profile of channels need not be symmetrical about some axis of symmetry along or across the flow field plate and hence may be asymmetrical. However, symmetrical arrangement of channels may aid in manufacturing. In other embodiments, channels 218 may vary in depth in one manner whereas channels 216 may vary in depth to a lesser degree in the same or another manner or may not vary at all, depending on the local operating conditions. The depth profile of the channels may be chosen by a person of ordinary skill in the art for a particular application, depending on local conditions within the fuel cell stack under various operating conditions.

Flow field plate 200 may be manufactured out of two subplates 262, 263, as shown in FIGS. 3A-5B, and 7A-7B however, flow field plate 200 may also be manufactured out of a single plate as shown in FIG. 6. Where flow field plate 200 is manufactured out of two subplates, for example, as shown in FIGS. 7A-7B, the valleys of subplate 262 form channels 214 in major surface 202 and the valleys in subplate 263 forms channels 215 in the opposing major surface 203. The volume created by the corresponding landings of subplate 262 and subplate 263 may form coolant channels 270 that run within flow field plate 200, as shown, and which are fluidly coupled to the coolant inlet 208 and the coolant outlet 209. When manufactured out of subplates 262,263, subplates 262,263 may utilize flow field symmetry and permit subplates 262,263 to be made substantially identical so as to reduce part count, manufacturing complexity, manufacturing times and associated costs.

The cross section of the channels (in cooperation with an associated MEA when flow field plate is disposed in a fuel cell stack) may be substantially trapezoidal as shown in FIGS. 7A-7B and coolant channels 270 may be substantially hexagonal, as similarly shown. However, the shape of the cross section of the channels may be hemispherical, partially spherical, rounded, oblong, ellipsoidal, rectangular, triangular, polygonal or non-polygonal, for example. Further, channels may be linear as depicted in FIG. 2A or may be non-linear, or serpentine, for example. Also, inlets may be of a backfeed design as disclosed in U.S. Pat. No. 6,232,008 or may be straightfeed. A person of ordinary skill in the art may select the shape, nature and configuration of the channels for a desired application.

The flow of the oxidant in one flow field and the fuel in another flow field may be in the same direction (co-flow) or may be in opposing directions (counterflow). Arrows in FIGS. 3A-4B shows the general oxidant flow direction from the reactant inlet through to the outlet. FIGS. 3A and 3B show a counter-flow configuration and FIGS. 4A and 4B show a co-flow configuration. A person of ordinary skill in the art may select co-flow or counterflow as desired for a particular application.

Flow field plate 200 or constituent subplates 262,263 may be manufactured by methods known in the art including stamping, milling, casting, embossing and those disclosed in U.S. Pat. No. 6,818,165 for example. U.S. Pat. No. 6,818,165 discloses a method for fabricating fluid flow field plates that are suitable for use in an electrochemical fuel cell assembly. Pursuant to the method, a fluid flow field channel region such as, for example, substantially straight, parallel fluid flow field channels, is roller embossed in a sheet of compressible, electrically conductive material such as, for example, expanded graphite sheet material. A fluid distribution region such as, for example, a region containing manifold openings and supply channels, is then reciprocally embossed in the sheet material. A sheet pre-impregnated with a curable polymeric composition, such as pre-impregnated expanded graphite, can be employed, with the curing being performed after the roller embossing and reciprocal embossing.

Subplates may be welded, laser welded, glued, epoxyed, or mechanically fastened together, for example.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to flow field plates and fuel cells, not necessarily the exemplary flow field plates and fuel cells generally described above.

The various embodiments described above can be combined to provide further embodiments. To the extent that they are not inconsistent with the specific teachings and definitions herein, all of the above U.S. patents, U.S. patent application publications, U.S. patent applications, foreign patents, foreign patent applications and non-patent publications referred to in this specification and/or listed in the Application Data Sheet are incorporated herein by reference, in their entirety.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A flow field plate, comprising:
a first surface having a plurality of first channels; wherein a first subset of the plurality of first channels has a first depth profile; wherein a second subset of the plurality of first channels has a second depth profile; and wherein the second depth profile differs from the first depth profile.

2. The flow field plate of claim 1 wherein the first depth profile varies from deep to shallow from a first inlet to a first outlet.

3. The flow field plate of claim 1 wherein the first depth profile changes in a linear fashion along at least a portion of each of the first channels of the first subset of the plurality of first channels.

4. The flow field plate of claim 1 wherein the first depth profile changes in a ramp-wise fashion along at least a portion of each of the first channels of the first subset of the plurality of first channels.

5. The flow field plate of claim 1 wherein the first depth profile changes in a non-linear fashion along at least a portion of each of the first channels of the first subset of the plurality of first channels.

6. The flow field plate of claim 1 wherein the width of each of the first channels of the plurality of first channels is substantially constant.

7. The flow field plate of claim 1, further comprising:
a second surface having a plurality of second channels wherein for each pair of the first channel and a respective one of the second channels, a sum of a depth of the first channels and a depth of the respective one of the second channels is substantially constant along a length of the first and the second channels.

8. The flow field plate of claim 1 wherein at last a portion of the flow field plate comprises a metal.

9. The flow field plate of claim 1 wherein at least a portion of the flow field plate comprises carbon.

10. A fuel cell stack, comprising:
a plurality of fuel cells coupled in series, at least one of the plurality of fuel cells comprising:
a pair of flow field plates,
a pair of fluid distribution layers interposed between the flow field plates;
a proton exchange membrane interposed between the fluid distribution layers; and
an electrocatalyst interposed between each of the fluid distribution layers and the proton exchange membrane
wherein at least one of the flow field plates comprises:
a first surface having a plurality of first channels; wherein a first subset of the plurality of first channels has a first depth profile; wherein a second subset of the plurality of first channels has a second depth profile; and wherein the second depth profile differs from the first depth profile.

11. The fuel cell stack of claim 10 wherein the first depth profile varies from deep to shallow from a first inlet to a first outlet.

12. The fuel cell stack of claim 10 wherein the first depth profile changes in a ramp-wise fashion along at least a portion of the first channels of the first subset of the first channels.

13. The fuel cell stack of claim 10 wherein the first depth profile changes in a non-linear fashion along at least a portion of the first channels of the first subset of the first channels.

14. The fuel cell stack of claim 10 wherein a width of each of the first channels in the plurality of first channels is substantially constant along a length of a respective one of the first channels.

15. The fuel cell stack of claim 10, further comprising:
a second surface having a plurality of second channels, the second channels in registration with respective ones of the first channels, wherein a sum of a depth of the first and the second channels that are in registration is substantially constant along the length of the channels.

16. The fuel cell stack of claim 10 wherein at last a portion of the flow field plate comprises a metal.

17. The fuel cell stack of claim 10 wherein at last a portion of the flow field plate comprises carbon.

18. A flow field plate, comprising:
a first surface having a plurality of first channels;
a second surface having a plurality of second channels, each of the second channels corresponding to a respective one of the first channels;
wherein a width of the at least a portion of the plurality of first channels and the plurality of second channels is substantially constant;
wherein an inner subset of the plurality of first channels has a first depth profile; wherein an outer subset of the plurality of first channels has a second depth profile, and
the second depth profile varies from deep to shallow from an inlet to an outlet;
wherein the second depth profile is different from the first depth profile; and
wherein a sum of the depth of at least one of the plurality of first channels and at least one of the plurality of corresponding second channels is constant along the length of the first and the second channels.

19. The flow field plate of claim 18 wherein the first depth profile is substantially constant from the inlet to the outlet.

20. A fuel cell comprising a flow field plate, the flow filed plate comprising:
a first surface having a plurality of first channels;
a second surface having a plurality of second channels, each of the second channels corresponding to a respective one of the first channels;
wherein a width of the at least a portion of the plurality of first channels and the plurality of second channels is substantially constant;
wherein an inner subset of the plurality of first channels has a first depth profile; wherein an outer subset of the plurality of first channels has a second depth profile, and
the second depth profile varies from deep to shallow from an inlet to an outlet;
wherein the second depth profile is different from the first depth profile; and
wherein a sum of the depth of at least one of the plurality of first channels and at least one of the plurality of corresponding second channels is constant along the length of the first and the second channels.

21. A fuel cell comprising a flow field plate, the flow field plate comprising:
a first surface having a plurality of first channels; wherein a first subset of the plurality of first channels has a first depth profile; wherein a second subset of the plurality of first channels has a second depth profile; and wherein the second depth profile differs from the first depth profile; and
a second surface having a plurality of second channels wherein for each pair of the first channel and a respective one of the second channels, a sum of a depth of the first channels and a depth of the respective one of the second channels is substantially constant along a length of the first and the second channels.

22. A flow filed plate comprising:
a first surface having a first flow field having a first depth profile;
a second surface having a second flow field having a second depth profile;
wherein a sum of a depth of the first flow field and a depth of the second flow field is substantially constant over the surface of the first and the second flow fields.

23. A method for making a flow field plate comprising:
providing a plate having at least a first surface and a second surface opposed to the first surface;
forming a plurality of first channels in the first surface of the plate; wherein a first subset of the plurality of first channels has a first depth profile; wherein a second subset of the plurality of first channels has a second depth profile; and wherein the second depth profile differs from the first depth profile.
